(19) United States
(12) Patent Application Publication
(10) Pub. No.: US 2008/0302616 A1
(43) Pub. Date: Dec. 11, 2008

(54) Brake disk with grooves

(76) Inventor: Ching-Wen Kao, Taichung (TW)

Correspondence Address: Kao, Ching-Wen, P.O. Box 44-2049, Taipei, 10668, TW

(21) Appl. No.: 11/808,439

(22) Filed: Jun. 11, 2007

(51) Int. Cl. F16D 65/12

(52) U.S. Cl. 188/218 XL

(57) ABSTRACT

A brake disk includes a central hole so as to be connected to a wheel shaft and a serrated periphery which includes a plurality of first protrusions and a second protrusion is located between any two adjacent first protrusions. Two recesses are connected between the second protrusion and the two adjacent first protrusions. A plurality of first grooves and second grooves are defined in each of two sides of the brake disk. Each second groove communicates with the first groove corresponding thereto so that rain drops, dust and debris from lining plates of calipers can be easily removed from the brake disk.

### BACKGROUND OF THE INVENTION

(1) Field of the Invention

The present invention relates to a brake disk with grooves defined in each side thereof so as to remove dust, rain drops and debris of lining plates on calipers.

(2) Description of the Prior Art

A conventional brake disk for vehicles, motorbikes or bicycles generally is a circular disk which is fixed to the wheel shaft and a caliper is used to caliper the brake disk to shop the wheel. The conventional brake disk includes holes for dispensing heat and reducing weight. The two sides of the conventional brake disk usually are smooth so that when rain drops, dust or debris of lining plates on the calipers are attached to the surfaces of the two sides of the conventional brake disk, the friction between the brake disk and the caliper is reduced.

The present invention intends to provide a brake disk which includes serrated periphery and grooves are defined in each of the two sides of the brake disk. The grooves communicate with the serrated periphery so as to guide the rain drops, the dusts and the debris of the lining plates to escape from the brake disk.

### SUMMARY OF THE INVENTION

The present invention relates to a brake disk mounted to a wheel shaft and includes a serrated periphery which includes a plurality of first protrusions and a second protrusion is located between any two adjacent first protrusions. Two recesses are connected between the second protrusion and the two adjacent first protrusions. A plurality of first grooves and second grooves are defined in each of two sides of the brake disk. Each second groove communicates with the first groove corresponding thereto.

The primary object of the present invention is to provide a brake disk with grooves in each side thereof so as to guide rain drops, dust and debris of lining plates of calipers away from the brake disk.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a side view of the brake disk of the present invention;

FIG. 2 shows a part of the brake disk and the first and second grooves communicate with recesses of the periphery of the brake disk;

FIG. 3 shows the calipers caliper at a first position of the brake disk, and

FIG. 4 shows the calipers caliper at a second position of the brake disk.

### DETAILED DESCRIPTION OF THE PREFERRED EMBODIMENTS

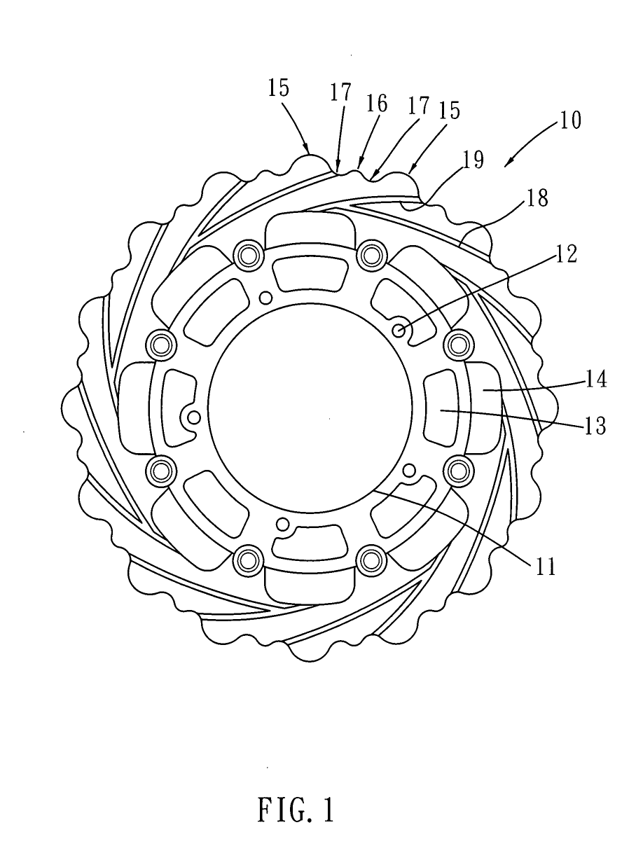

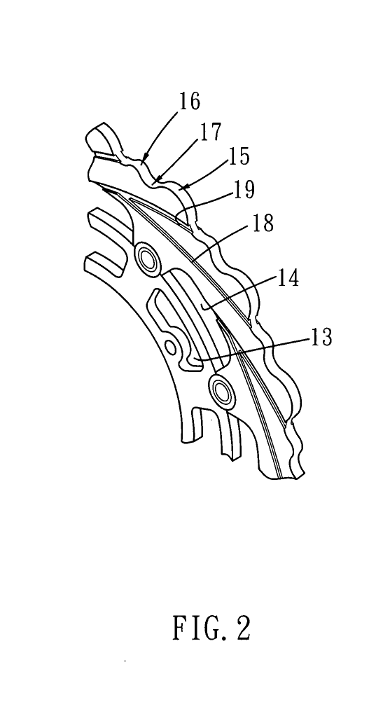

Referring to FIGS. 1 and 2, the brake disk 10 of the present invention comprises a central hole 11 through which a wheel shaft (not shown) extends, and a plurality of connection holes 12 are defined in the brake disk 10 so as to connect the brake disk 10 to a flange (not shown) on the wheel shaft. A first and second through holes 13, 14 are defined through the brake disk 10 so as to reduce the weight of the brake disk 10 and increase the efficiency of heat dispensing.

The brake disk 10 includes a serrated periphery which includes a plurality of first protrusions 15 and a second protrusion 16 located between any two adjacent first protrusions 15. Two recesses 17 connect between the second protrusion 16 and the two adjacent first protrusions 15. The radial length of the first protrusions 15 is longer than the radial length of the second protrusion 16.

A plurality of first grooves 18 and second grooves 19 are defined in each of two sides of the brake disk 10. Each second groove 19 communicates with the first groove 18 corresponding thereto, and a depth of each first groove 18 is less than a depth of each second groove 19. Preferably, the depth of the fist grooves 18 is made to be the same as the depth of the safety check depth of the brake disk 10 so that the user can easily check the wearing of the brake disk 10 and replace the brake disk 10 when needed. Each of the first and second grooves 18, 19 communicates with one of the recesses 17, and each of the second grooves 19 communicates with one of the through holes 14. The number and size of the first and second protrusions 15, 16 can be varied according to needs.

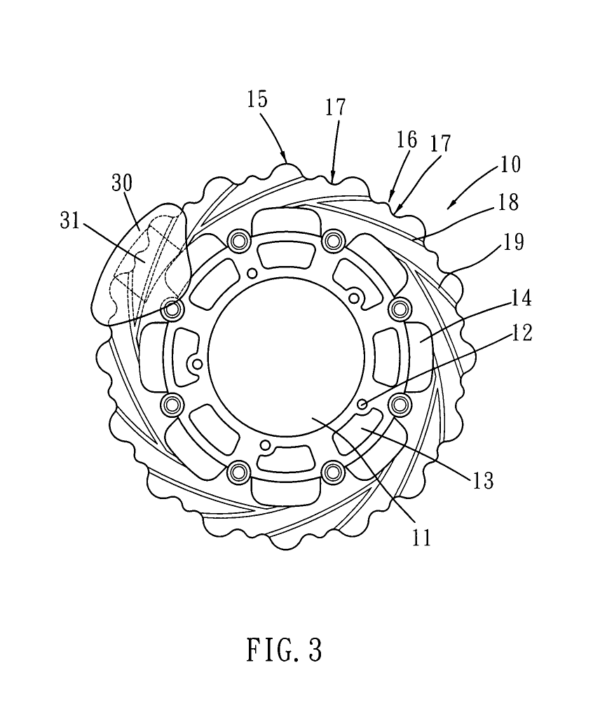

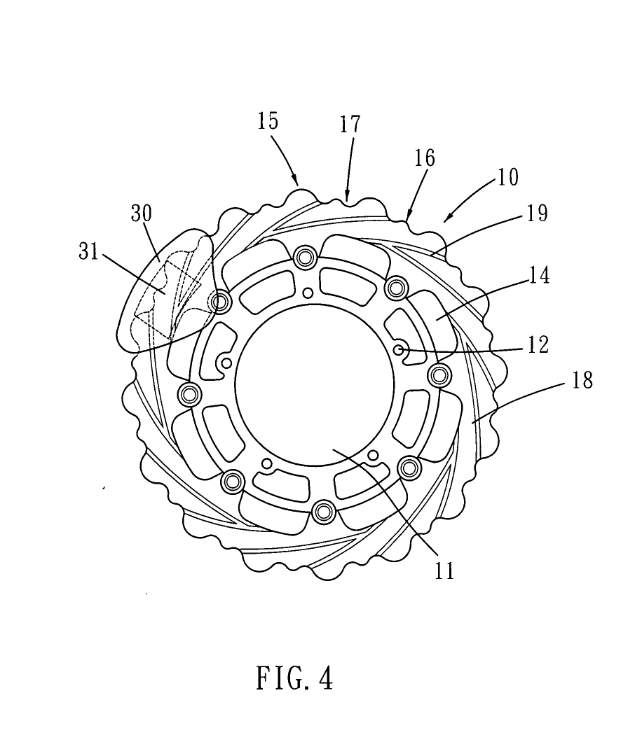

As shown in FIGS. 3 and 4, when the calipers 30 clamps the brake disk 10 at the first position where the lining plate 31 is located between the two adjacent first protrusion 15, the lining plates 31 are supported by the second protrusion 16 and the wearing of the lining plates 31 is even. The rain drops, the dust and the debris of the lining plates 31 can be easily removed from the brake disk 10 via the first and second grooves 18, 19.

While we have shown and described the embodiment in accordance with the present invention, it should be clear to those skilled in the art that further embodiments may be made without departing from the scope of the present invention.

What is claimed is:

1. A brake disk comprising:
a central hole and a serrated periphery which includes a plurality of first protrusions and a second protrusion located between any two adjacent first protrusions, two recesses connecting between the second protrusion and the two adjacent first protrusions, and
a plurality of first grooves and second grooves defined in each of two sides of the brake disk, each second groove communicating with the first groove corresponding thereto.

2. The brake disk as claimed in claim 1, wherein a depth of each first groove is less than a depth of each second groove.

3. The brake disk as claimed in claim 1, wherein each of the first and second grooves communicates with one of the recesses.

4. The brake disk as claimed in claim 1, wherein a plurality of through holes defined through the brake disk and each of the second grooves communicates with one of the through holes.
